(19) United States
(12) Patent Application Publication
(10) Pub. No.: US 2012/0022940 A1
(43) Pub. Date: Jan. 26, 2012

(54) System Configured to Provide a Software Application to a User Computing Device, Method of Providing Software Application, and Method of Advertising

(75) Inventor: Kevin Torf, Palos Verdes Estate, CA (US)

(73) Assignee: Bet Tracker, LLC, Palos Verdes Estate, CA (US)

(21) Appl. No.: 12/841,087

(22) Filed: Jul. 21, 2010

(51) Int. Cl. G06Q 30/00; G06F 9/445

(52) U.S. Cl. 705/14.49; 717/177; 705/14.4

(57) ABSTRACT

In some examples, a method of advertising can include: facilitating providing of a first promotional code to a user, the first promotional code provides at least one privilege to the user; facilitating providing of a first software application to the user; receiving the first promotional code from the first software application; and changing one or more first elements of the first software application based on the first promotional code to alter a look and feel of the first software application. Changing the one or more first elements can include embedding promotional materials in one or more user screens of the first software application. Other embodiments are disclosed.

### FIELD OF THE INVENTION

This invention relates generally to electrical devices, and relates more particularly to systems for providing a software application to an electrical device and/or enabling features in the software application running on an electrical device, methods of providing the same, and methods of advertising.

### DESCRIPTION OF THE BACKGROUND

Currently, one method for distributing software to consumers is through a licensing scheme. A typical software license is a contract that permits the licensee to use certain software in compliance with specified terms and conditions in exchange for a payment. Payment may or may not be financial in nature. An example of non-financial payment is a scenario wherein a consumer agrees to publish, for public consumption, improvements to a software application in exchange for the right to use the application in its current condition.

In some instances, a consumer pays for a license to use computer software before access is to the computer software is granted. In other cases, a consumer may be granted free access during a trial period that precedes an actual license of the same or similar product. The version of the software accessed during the trial period may be the same or different as compared to the version that is actually licensed. The trial version is sometimes a scaled-down version of the actual licensed product. The examples provided herein are only a few of many schemes currently implemented to facilitate the distribution of software to consumers.

The Internet provides opportunities for other methods of software distribution. In fact, there is currently a trend towards providing some level of free online software functionality that is supplemented with advertisements. One particular example of this is search engine advertising, where advertisers pay for placement of an advertisement relative to searches conducted by search engine users.

Accordingly, there is a need for systems and methods that facilitate advertisement-funded software development in a manner that is potentially appealing to software developers, advertisers, and/or consumers.

### BRIEF DESCRIPTION OF THE DRAWINGS

To facilitate further description of the embodiments, the following drawings are provided in which:

FIG. 1 is a schematic block diagram of a system, according to a first embodiment;

FIG. 2 illustrates an example of a user computing device running an example of a user module of the system of FIG. 1, according to the first embodiment;

FIG. 3 illustrates an example of a user screen of a user module of the system of FIG. 1 after a sponsoring entity's logos have been added to the user screen of the user module, according to the first embodiment;

FIG. 4 illustrates a flow chart of a method of providing a software application to one or more users, according to the first embodiment;

FIG. 5 illustrates an example of a user screen of a user module of the system of FIG. 1 where a user can enter a promotional code, according to the first embodiment;

FIG. 6 illustrates an example of the user computing device of FIG. 2 where a user screen of a user module of the system of FIG. 1 has been branded with advertising material of the sponsoring entity, according to a first embodiment;

FIG. 7 illustrates another example of the user computing device of FIG. 2 where a user screen of a user module of the system of FIG. 1 has been branded with advertising material of the sponsoring entity, according to a first embodiment;

FIG. 8 illustrates an example of a user screen of a user module of the system of FIG. 1 where a user can choose between three promotional codes, according to a first embodiment;

FIG. 9 illustrates a computer that is suitable for implementing an embodiment of the system of FIG. 1; and

FIG. 10 illustrates a representative block diagram of an example of the elements included in the circuit boards inside the chassis of the computer of FIG. 9.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

In some examples, a method of advertising can include: facilitating providing of a first promotional code to a user, the first promotional code provides at least one privilege to the user; facilitating providing of a first software application to the user; receiving the first promotional code from the first software application; and changing one or more first elements of the first software application based on the first promotional code to alter a look and feel of the first software application. Changing the one or more first elements can include embedding promotional materials in one or more user screens of the first software application.

Other embodiments concern a system configured to facilitate advertising to one or more users of one or more user computing devices. The system can include: (a) a user module configured to run on the one or more user computing devices; and (b) a server module configured to run on a server computer. The server module can include: (a) a download module configured to facilitate the downloading of the user module to the one or more user computing devices; and (b) a promotional code module configured to determine one or more first elements of the user module to change based on one or more promotional codes. The user module can include: (a) a feature module configured to provide one or more features; a communications module configured to receive the one or more promotional codes from the one or more users and communicate with the server module; and a implementation module configured to change the one or more first elements of the user module based on the one or more promotional codes.

Still further embodiments concern a method of providing a first software application to one or more users. The method can include: entering an agreement with a distributor regarding distribution of the first software application; creating one or more promotional codes for the distributor based on the agreement; facilitating providing of the one or more promotional codes to the one or more users; facilitating downloading of the first software application by the one or more users, facilitating downloading can include at least one of the following: providing the distributor the first software application for distribution to the one or more users; or distributing the first software application to the one or more users; facilitating installing of the first software application by the one or more users in one or more user computing devices; receiving a first promotional code of the one or more promotional codes using the first software application on a first one of the one or more user computing devices; transmitting the first promotional code of the one or more promotional codes to a server computer; receiving the first promotional code of the one or more promotional codes using the server computer; determining one or more benefits of the first promotional code of the one or more promotional codes; transmitting information regarding the one or more benefits to the first software application running on the first one of the one or more user computing devices; implementing the one or more benefits of the first promotional code in the first software application running on the first one of the one or more user computing devices. Implementing the one or more benefits can include: branding one or more user screens of the first software application running on the first one of the one or more user computing devices with advertising materials of the distributor.

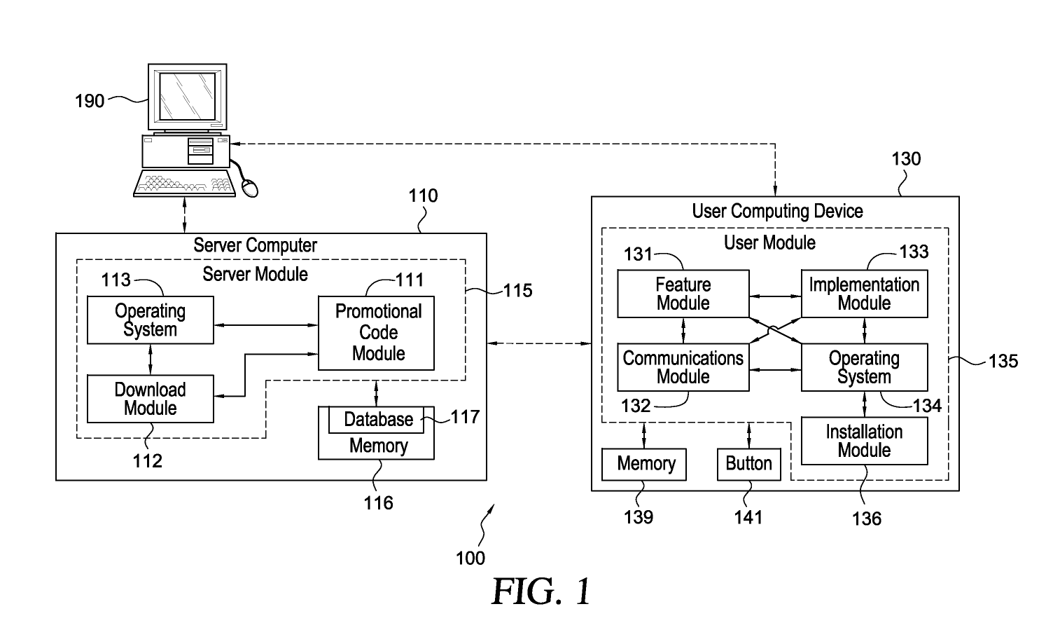

Turning to the drawings, FIG. 1 is a schematic block diagram of system 100, according to a first embodiment. System 100 is merely exemplary and is not limited to the embodiments presented herein. System 100 can be employed in many different embodiments or examples not specifically depicted or described herein.

Not to be taken in a limiting sense, a simple example of an implementation of system 100 is that a sponsoring entity offers a computer application to run on a mobile device or a personal computer. The computer application is offered to the sponsoring entity's or a third party's customer base as part of a reward and/or promotional campaign. Also as part of this campaign, the sponsoring entity and/or the third markets and distributes promotional codes for use with the computer application. A customer downloads and installs this computer application (i.e., user module 135) onto, for example, a user computing device 130. After installation, user module 135 can prompt the user to enter a promotional code.

After the user enters the promotional code, user module 135 communicates the promotional code to server module 115 running on server computer 110. Server module 115 determines one or more elements of user module 135 to change based on the privileges or benefits of the promotional code and communicates the change(s) to user module 135. That is, after receiving the promotional code, user module 135 can be changed in various ways based on the privileges or benefits granted and tied to the promotional code. In some embodiments, entering the promotional code can change the look and feel of one or more user screens of user module 135 when user module 135 is running on user computing device 130. For example, the user screens could, after modification, display the logo of the sponsoring entity or third party and brand the user screens so the computer application looks like it was provided by the sponsoring entity or third party, even if user module 135 is provided by a different party (i.e., a software provider entity). Accordingly, system 100 provides a mechanism by which a sponsoring entity or third party can advertise its brand while providing something of value to its customers.

In some embodiments, system 100 can be considered a system configured to provide advertising or configured to provide a first application to one or more users. System 100 can include: (a) server computer 110 with server module 115 and a memory 116; and (b) user computing device 130 with user module 135, a memory 139, and one or more buttons 141.

Server module 115 can include one or more computer modules configured to run on server computer 110. Server module 115 can include: (a) a promotional code module 111 configured to determining the one or more first elements of user module 135 to change based on a promotional code; and (b) a download module 112 configured to facilitate the downloading of user module 135 to user computing device 130; and (c) an operating system 113.

User module 135 can be configured to run on user computing device 130, which can be, for example, a mobile device or a personal computer. User module 135 can include: (a) a feature module 131 configured to provide one or more features or functionalities to a user of user computing device 130; (b) a communications module 132 configured to receive a promotional code from the user and communicate with server module 115; (c) an implementation module 133; (d) an installation module 136; and (e) an operating system 134.

Feature module 131 can be configured to provide the user with the functionality of user module 135. For example, if user module 135 is sports wager tracking software, feature module 131 can provide the sports wager tracking functionality. If user module 135 is a software program that provides restaurant reviews, feature module 131 can be the portion of user module 135 that provides the functionality of displaying restaurant reviews to the user.

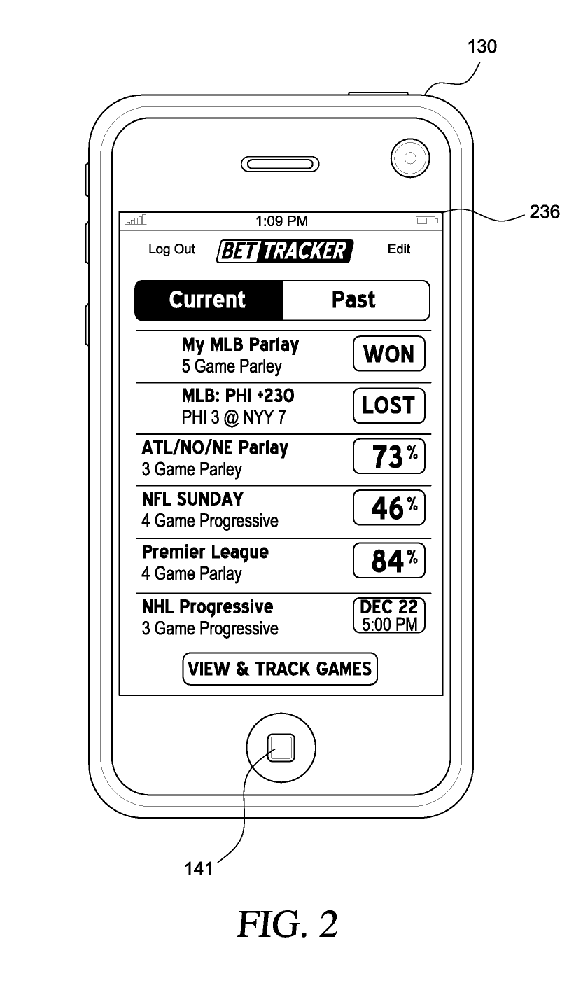

In some examples, feature module 131 can, in part, provide one or more user screens on user computing device 130. For example, FIG. 2 illustrates an example of a user computing device 130 running an example of user module 135, according to the first embodiment. In this example, user module 135 is wager tracking software, and FIG. 2 illustrates an example of a user screen 236.

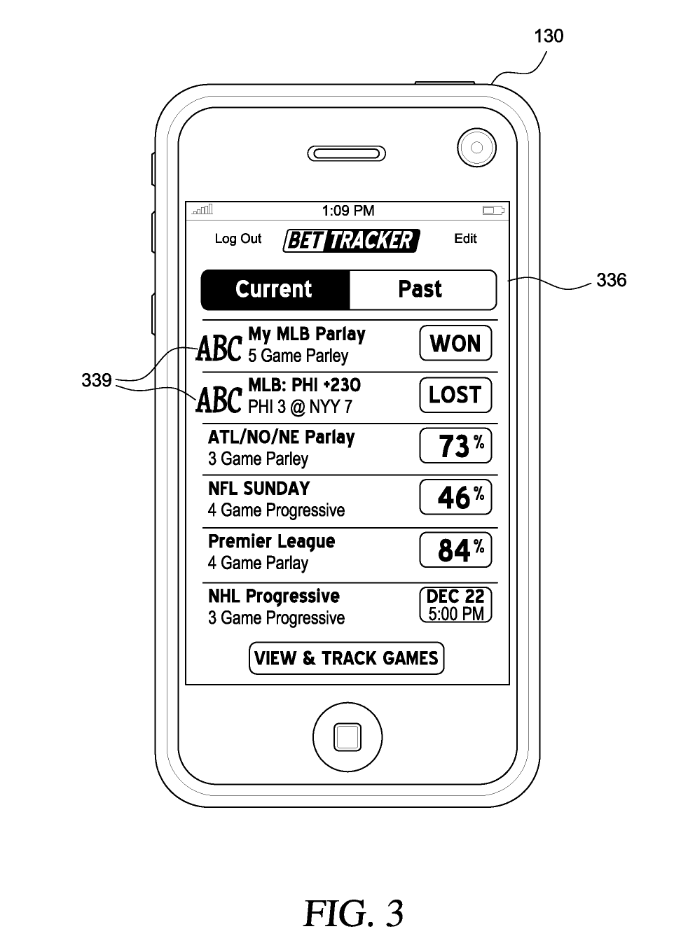

Implementation module 133 can be configured to change the one or more first elements of user module 135 based on a promotional code. For example, implementation module 133 can change elements of user module 135 such that: (a) a discount (e.g., 20 percent (%) is provided on a purchase of the user module 135; (b) free use of user module 135 is provided for a predetermined period of time (e.g., two weeks); (c) one or more features of user module 135 (e.g., the ability to share data with other users of user module 135) are enabled; (d) use of user module 135 for a predetermined number of times (e.g., allowing ten free uses of user module 135) is provided; and/or (e) altering the look and feel of one or more user screens by, for example, (1) branding user module 135 with advertising material of the sponsor entity; (2) embedding promotional materials in one or more user screens of user module 135; and/or (3) inserting a logo of the sponsoring entity into one or more user screens of user module 135. In some examples, as part of altering the look and feel of user module 135, implementation module 133 can change a color of a background of the one or more user screens of user module 135. For example, FIG. 3 illustrates an example of a user screen 336 after a sponsoring entity's logos 339 have been added to user screen 336, according to the first embodiment. That is, logos 339 have added to user screen 336 to brand user module 135 after the user entered a promotional code.

In some examples, a sponsoring entity can contract with a software provider entity to distribute the computer software (i.e., user module 135), which can be owned and/or developed by the software provider entity. The sponsoring entity and/or the software provider entity can distribute the computer software along with the promotional code to alter the computer software. Referring again to FIG. 1, in some examples, server computer 110 and user computing device 130 can communicate with a software provider or sponsoring entity's computer system 190. In some examples, user computing device 130 or the user can communicate with computer system 190 to obtain the promotional code. The user can receive (i.e., download) user module 135 from server computer 110. In some examples, server computer 110 can be owned and/or operated by or on behalf of software provider entity. In other examples, server computer 110 can be owned and/or operated by or on behalf of the sponsoring entity.

“Server computer 110,” as used herein, can refer to a single computer, single server, or a cluster or collection of servers. Typically, a cluster or collection of servers can be used when the demands by client computers (e.g., one or more user computing device 130) are beyond the reasonable capability of a single server or computer. In many embodiments, the servers in the cluster or collection of servers are interchangeable from the perspective of the client computers.

In some examples, a single server can include promotional code module 111 and download module 112. In other examples, a first server can include a first portion of these modules. One or more second servers can include a second, possibly overlapping, portion of these modules. In these examples, server computer 110 can comprise the combination of the first server and the one or more second servers.

In some examples, memory 116 of server computer 110 can include a database 117. Database 117 can be a structured collection of records or data which is stored in memory 116. For example, database 117 can be an XML (Extensible Markup Language) database, MySQL, or an Oracle® database. In the same or different embodiments, the database 117 could consist of a searchable group of individual data files stored in memory 116. In some examples, information regarding one or more promotional codes is stored in database 117.

In various embodiments, operating systems 113 and 134 can be software programs that manage the hardware and software resources of a computer and/or a computer network. Operating systems 113 and 134 perform basic tasks such as, for example, controlling and allocating memory, prioritizing the processing of instructions, controlling input and output devices, facilitating networking, and managing files. Examples of common operating systems for a computer include Microsoft® Windows, Mac® operating system (OS), UNIX® OS, and Linux® OS. Common operating systems for a mobile device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or a Symbian operating system by Nokia Corp. of Espoo, Finland.

In some examples, user computing device 130 can include electrical devices of all types and designs (e.g., media players, telephones, audio-visual media players, and devices incorporating media players, telephones, and/or audio-visual devices). For example, user computing device 130 can be an electrical device manufactured by Sony Corp., Philips Corp., Audiovox Corp., Microsoft Corp. (e.g., the Zune® MP3 player), Research in Motion Limited (e.g., the Blackberry® device), Palm, Inc. (e.g., the Palm® device), or Apple Computer, Inc. (e.g., the iPod® MP3 player, the iTouch® device, iPad® device, and/or the iPhone® device).

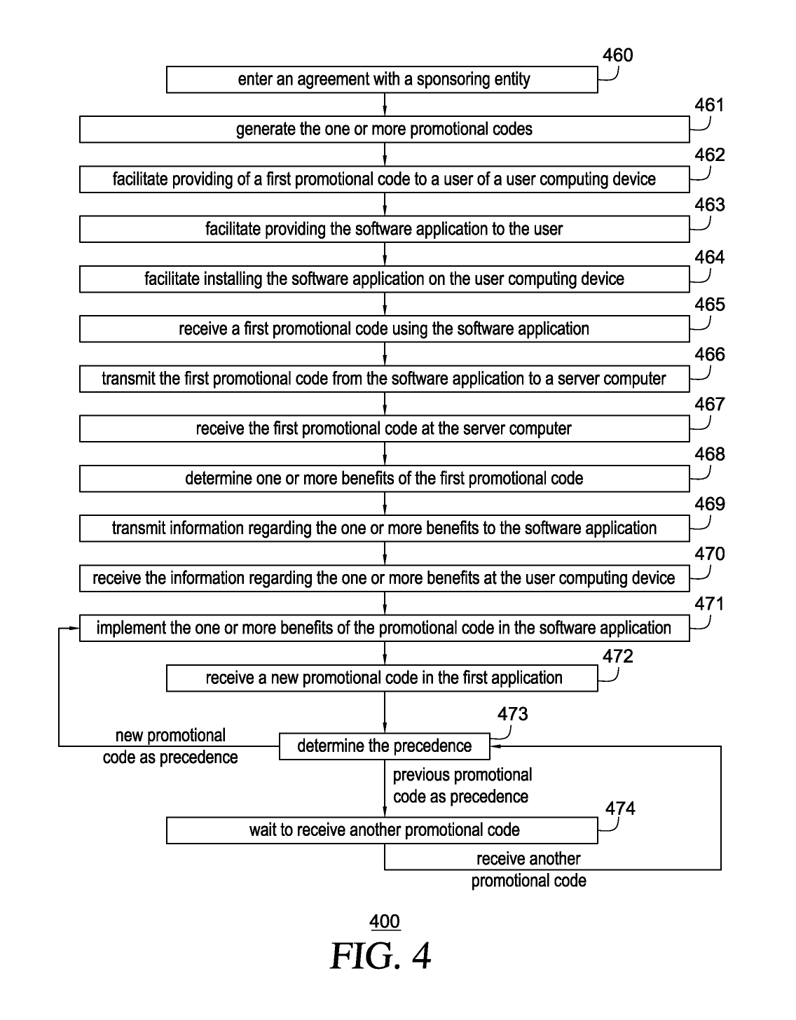

FIG. 4 illustrates a flow chart of a method 400 of providing a software application to one or more users, according to the first embodiment. Method 400 can also be considered a method of providing advertising materials to one or more users. Method 400 and system 100 can be employed in many different embodiments or examples not specifically depicted or described herein. In some embodiments, the activities, the procedures, and/or the processes of method 400 can be performed in the order presented. In other embodiments, the activities, the procedures, and/or the processes of the method 400 can be performed in any other suitable order. In still other embodiments, one or more of the activities, the procedures, and/or the processes in method 400 can be combined or skipped.

Referring to FIG. 4, method 400 includes an activity 460 of entering an agreement with a sponsoring entity. In some examples, the sponsoring entity is a distributor who will distribute the software application and one or more promotional codes. In some examples, the agreement defines the terms of the distribution of a software application and one or more promotional codes. The agreement can determine benefits or privileges of one or more promotional codes, a cost to the sponsoring entity for one or more promotional codes, and/or a cost to the sponsoring entity of the rights to distribute the software application. In some examples, the software application can be user module 135 of FIG. 1.

In some examples, activity 460 can be skipped if the sponsoring entity already owns the rights to the software application (and can provide and process promotional codes) or otherwise does not need to enter an agreement with a software provider entity to obtain promotional codes or the rights to the software application.

Referring again to FIG. 4, method 400 continues with an activity 461 of generating the one or more promotional codes. Activity 461 can also be considered creating one or more promotional codes for a distributor based on the agreement, in various embodiments. In some examples, promotional code module 111 (FIG. 1) can generate one or more promotional codes with one or more benefits or privileges based on the terms of the agreement. In other examples, a user can manually enter one or more promotional codes and the benefits of the promotional codes into server computer 110 (FIG. 1). The one or more promotional codes and information about their benefits can be stored in database 117 (FIG. 1). In some examples, the promotional codes can be an alpha-numeric sequence (e.g., A543B102). In other examples, the promotional codes can have other formats.

Subsequently, method 400 of FIG. 4 includes an activity 462 of facilitating providing of a first promotional code to a user of a user computing device. In some examples, facilitating providing the first promotional code can involve providing the one or more promotional codes to the sponsoring entity. For example, server computer 110 (FIG. 1) can electronically transfer the one or more promotional codes to computer system 190 (FIG. 1). The sponsoring entity can then distribute the one or more promotional codes to the potential users (e.g., the customer base of the sponsoring entity).

In other examples, facilitating providing the first promotional code can include providing the first promotional code to a user of the user computing device. For example, the first promotional code can be displayed on a web page, and/or emailed or texted to the user. In other examples, the first promotional code can be provided as part of written advertising materials or on a compact disc read-only memory (CD-ROM) or digital video disc (DVD) that contains the software application.

Next, method 400 of FIG. 4 includes an activity 463 of facilitating providing of the software application to the user. In some examples, facilitating providing of the software application can include providing the software application to the sponsoring entity. The sponsoring entity can then distribute the software application to potential users (e.g., its customer base).

In the same or different examples, facilitating providing of the software application can include distributing the software application to the users of the user computing device. For example, the software application can be provided on a website that a user can access to download the software application. In the same or different examples, the software application can be made available for download through an electronic online store. In other examples, the software application can be provided to the user using other electronic media (e.g., CD-ROM or DVD).

Referring again to FIG. 1, in various embodiments, download module 112 running on server computer 110 can facilitate the downloading of the software application (e.g., user module 135) from server computer 110 to user computing device 130. In other examples, the user can download the software application from computer system 190. In some examples, the first promotional code can be provided along with the software application (i.e., activities 462 and 463 can be concurrent or combined).

Referring again to FIG. 4, method 400 continues with an activity 464 of facilitating installing the software application on the user computing device. In some examples, facilitating installing the software application on the user computer device can include installing the software application on the user computing device. In some examples, installation module 136 (FIG. 1) can install user module 135 (FIG. 1) on user computing device 130 (FIG. 1). Installation module 136 (FIG. 1) can communicate with server computer 110 (FIG. 1) during the installation process in various embodiments. After installation module 136 (FIG. 1) finishes installing the software application, the user of the user computing device can use the software application and, for example, enter a promotional code.

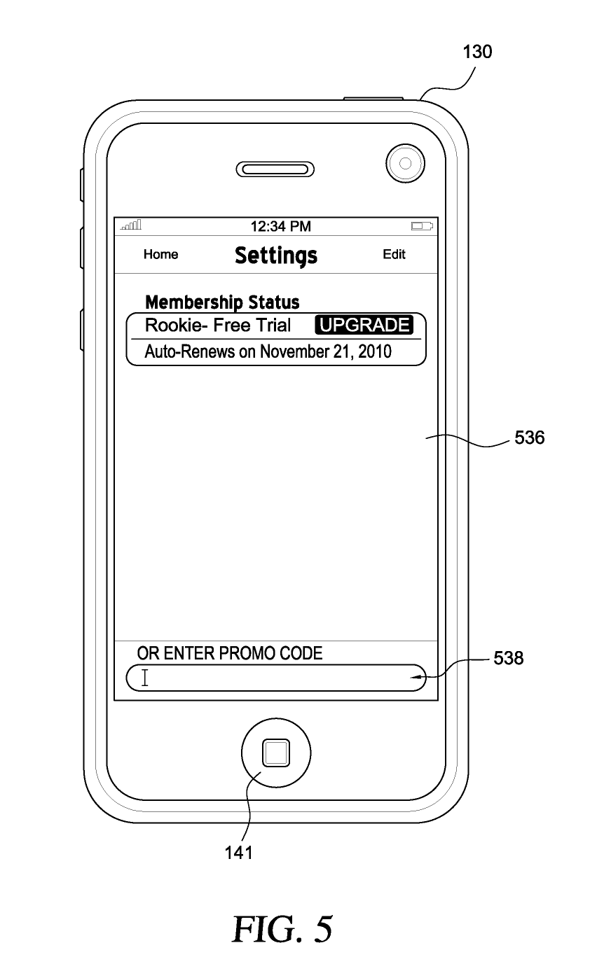

Subsequently, method 400 of FIG. 4 includes an activity 465 of receiving a first promotional code using the software application. In some examples, a user can enter a promotional code into the software application. For example, FIG. 5 illustrates an example of a user screen 536 on user computing device 130 where a user can enter a promotional code, according to the first embodiment. In the example shown in FIG. 5, a user can enter a promotional code into window 538 and press button 141 to submit the promotional code.

Next, method 400 of FIG. 4 includes an activity 466 of transmitting the first promotional code from the software application to a server computer. In some examples, communications module 132 (FIG. 1) can transmit the first promotional code to server computer 110 (FIG. 1). In some examples, communications module 132 (FIG. 1) can transmit the promotional codes over, for example, a cellular network, the Internet, or a combination thereof.

Referring again to FIG. 4, method 400 continues with an activity 467 of receiving the first promotional code at the server computer. In some examples, promotional code module 111 (FIG. 1) can receive the promotional code from user computing device 130 (FIG. 1).

Subsequently, method 400 of FIG. 4 includes an activity 468 of determining one or more benefits of the first promotional code. In some examples, promotional code module 111 (FIG. 1) can query database 117 (FIG. 1) to determine the benefits associated with the first promotional code. In other examples, promotional code module 111 (FIG. 1) can query computer system 190 (FIG. 1) to determine the benefits associated with the first promotional code. Examples of potential benefits of the first promotional code are discussed below.

Next, method 400 of FIG. 4 includes an activity 469 of transmitting information regarding the one or more benefits to the software application. In some examples, promotional code module 111 (FIG. 1) can transmit information regarding the benefits of the first promotional code to user module 135 (FIG. 2) running on user computing device 130 (FIG. 1).

Subsequently, method 400 of FIG. 4 includes an activity 470 of receiving the information regarding the one or more benefits at the user computing device. In some examples, communications module 132 (FIG. 1) can receive the information regarding the one or more benefits and communicate the one or more benefits to implementation module 133 (FIG. 1).

Referring again to FIG. 4, method 400 continues with an activity 471 of implementing the one or more benefits of the first promotional code in the software application. In some examples, implementation module 133 (FIG. 1) can apply the benefits to the software application.

Referring again to FIG. 1, for example, the benefits can include providing a discount on a purchase price of the user module 135. In this case, implementation module 133 can cause a user screen to be displayed where the user can purchase user module 135 for the discounted price.

In another example, the benefits can include providing free use of user module 135 for a predetermined period of time (e.g., two weeks). In this example, implementation module 133 can communicate to feature module 131 to allow the user to use the functionality of user module 135 for the predetermined period of time.

In still another example, the benefits can include enabling one or more features of user module 135 (FIG. 1). In this example, implementation module 133 can communicate to feature module 131 that one or more features of user module 135 should be enabled. Feature module 131 can enable the one or more features. For example, feature module 131 could enable functionality that allows the user to communicate information to other users of different user modules 135 or simultaneously perform more than one action with user module 135.

In further examples, the benefits can include allowing use of user module 135 for a predetermined number of times (e.g., allowing ten free uses of user module 135). In this example, implementation module 133 can communicate to feature module 131 to allow the user to use the functionality of user module 135 for the predetermined number of times.

In the same or different examples, the benefits can include altering the look and feel of one or more user screens. In some embodiments, implementation module 133 can alter the look and feel of one or more user screens by (1) branding user module 135 with advertising material of the sponsoring entity; (2) embedding promotional materials in one or more user screens of user module 135; and/or (3) inserting a logo of a company into the one or more user screens of user module 135. In some examples, the altering of the look and feel can also include changing a color of a background of the one or more user screens of user module 135.

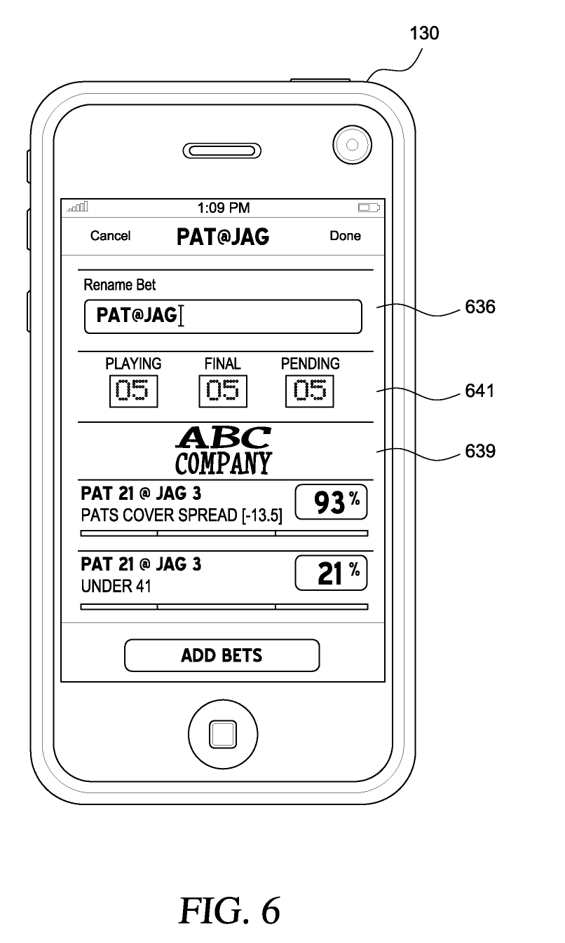

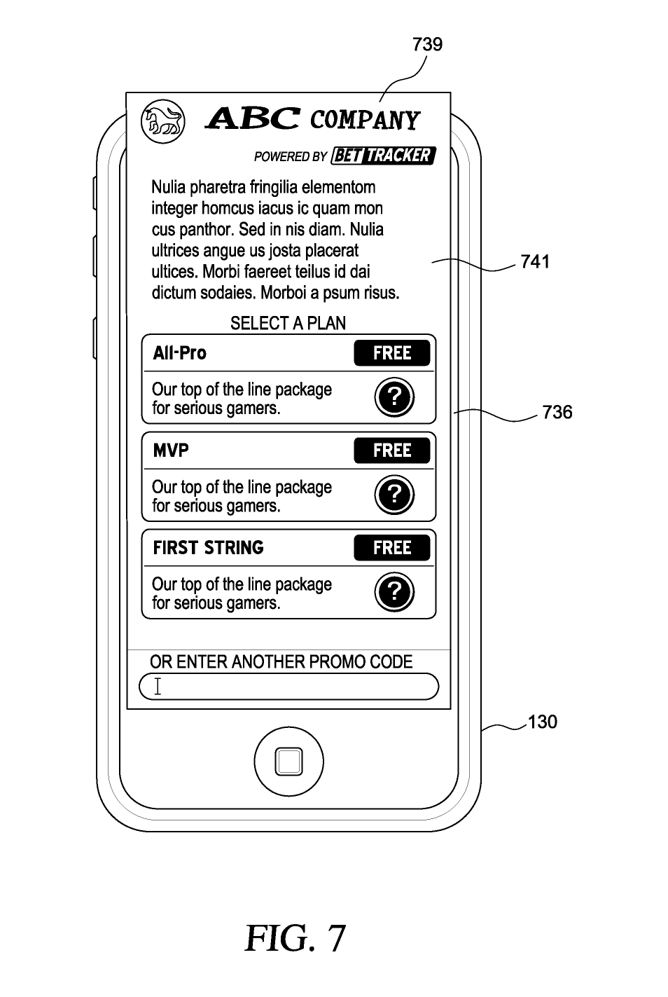

For example, FIG. 6 illustrates an example of user computing device 130 where user screen 636 of user module 135 has been branded with advertising material 739 of the sponsoring entity, according to a first embodiment. FIG. 7 illustrates another example of user computing device 130 where user screen 736 of user module 135 has been branded with advertising material 639 of the sponsoring entity, according to the first embodiment. In some examples, the colors of backgrounds 641 and 741 of user screens 636 and 736, respectively, can also be changed to a color chosen by the sponsoring entity. In other examples, the layout and organization of user screen 636 and 736 also can be changed. It is noted that user screen 736 is longer than the length of the display on user computing device 130 and is viewed in user computing device 130 using a scrolling device.

In both of the examples shown in FIGS. 6 and 7, user module 135 has been branded with advertising materials of the sponsoring entity such that to a user, and user module 135 can be considered a product of the sponsoring entity. Accordingly, a software distribution entity can distribute essentially the same program to several different users on behalf of different sponsoring entities. The promotional codes can be used by one or more sponsoring entities to customize the look and feel and/or functionality of user module 135 for their respective customer bases.

Subsequently, method 400 of FIG. 4 includes an activity 472 of receiving a second promotional code in the first application. In some examples, activity 472 can be similar or identical to activity 465 of FIG. 4.

Next, method 400 of FIG. 4 includes an activity 473 of determining the precedence of the first promotional code and the second promotional code. In some examples, if more than one promotional code is entered into user module 135, the promotional codes can have conflicting benefits. For example, a first promotional code could brand the application with a first sponsoring entity's advertising materials, and a second promotional code could brand user module 135 with a second sponsoring entity's advertising materials.

Accordingly, referring again to FIG. 1, system 100 needs to determine the precedence of the first promotional code and the second promotional code. In some examples, activity 473 can include transmitting the first and second promotional codes to promotional code module 111 (FIG. 1) using communications module 132 (FIG. 1). Promotional code module 111 (FIG. 1) can implement one or more predetermined rules to determine if a conflict exists between the first and second promotional code and, if so, how to resolve the conflict. For example, if the two promotional codes are conflicting, the first promotional code could have precedence over the second promotional code. In other examples, promotional codes from one or more first sponsoring entities can take precedence over promotional codes from one or more second sponsoring entities.

In various examples, if the first promotional code takes precedence over the second promotional code, promotional code module 111 (FIG. 1) can instruct communications module 132 (FIG. 1) to notify the user that the second promotional code cannot be used. If the second promotional code takes precedence over the first promotional code, promotional code module 111 (FIG. 1) can instruct communication module 132 (FIG. 1) to notify the user that the second promotional code will be used instead of the first promotional code.

If the promotional codes are not conflicting but rather complementary, promotional code module 111 (FIG. 1) can determine if the user is allowed to use both promotional codes simultaneously.

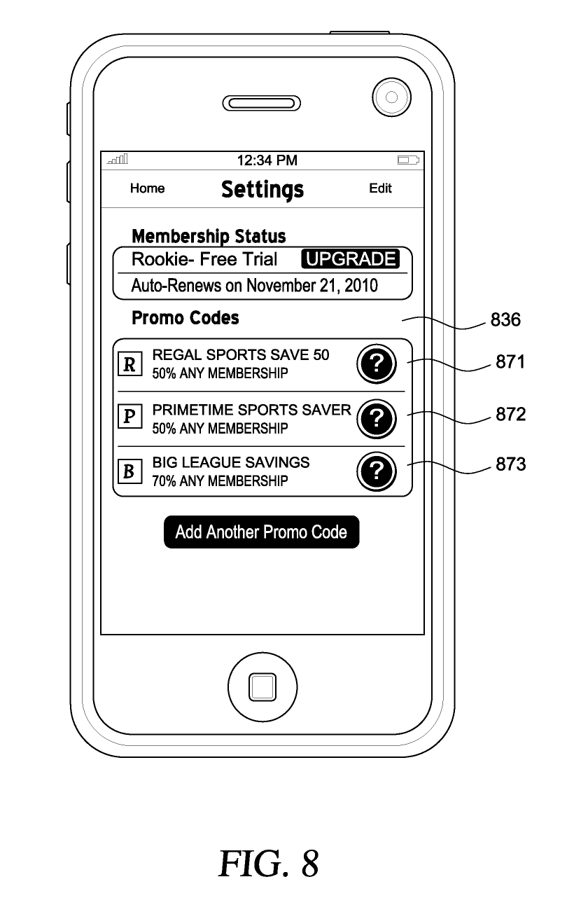

In still other examples, communications module 132 (FIG. 1) can inform the user of the benefits of each promotional code and let the user decide which promotional code to use. FIG. 8 illustrates an example of a user screen 836 of user module 135 where a user can choose between three promotional codes 871, 872, and 873, according to the first embodiment.

If the second promotional code is to be implemented, the next activity in method 400 is activity 471 of implementing the one or more benefits of the second promotional code in the software application.

If the second promotional code is not implemented, the next activity is an activity 474 of waiting to receive another promotional code. If another promotional code is received, the next activity is activity 473 of determining the precedence between the promotional codes.

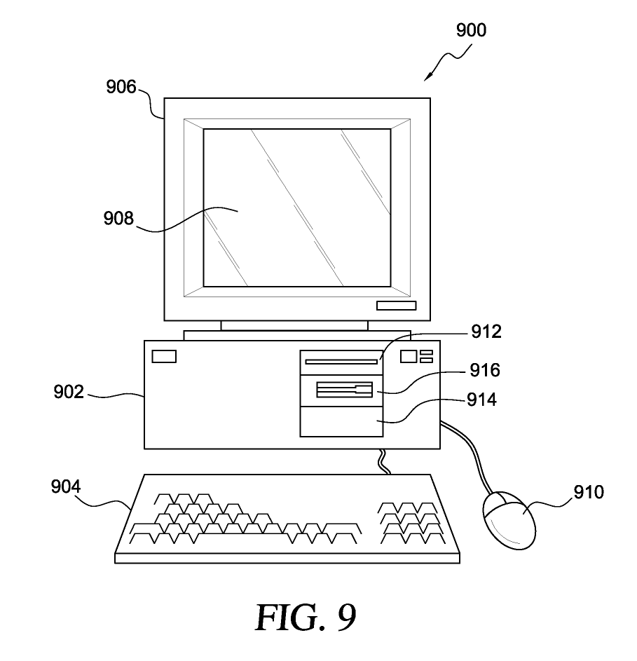

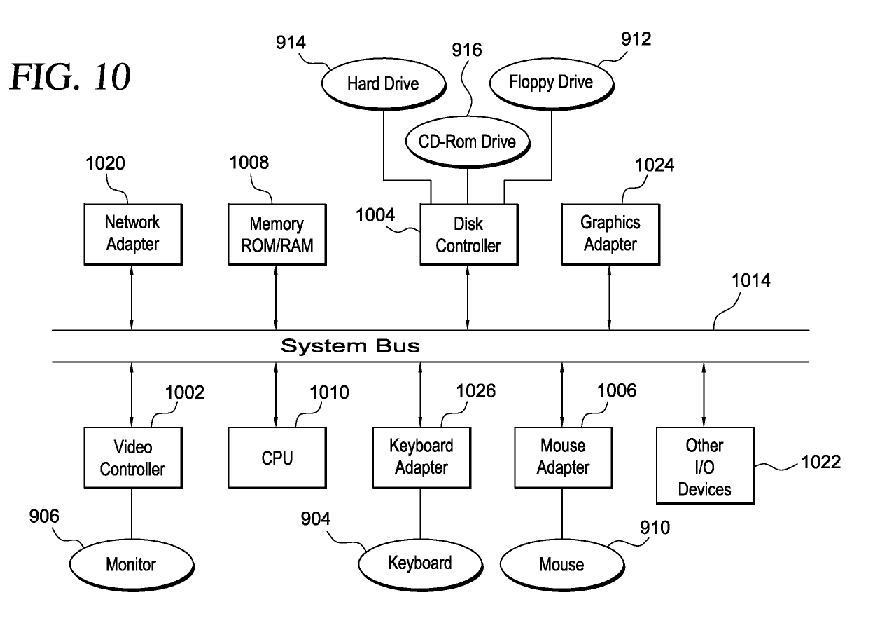

FIG. 9 illustrates a computer 900 that is suitable for implementing an embodiment of at least a portion of computer system 100 (FIG. 1). Computer 900 includes a chassis 902 containing one or more circuit boards (not shown), a floppy drive 912, a CD-ROM and/or DVD drive 916, and a hard drive 914. A representative block diagram of the elements included on the circuit boards inside chassis 902 is shown in FIG. 10. A central processing unit (CPU) 1010 in FIG. 10 is coupled to a system bus 1014 in FIG. 10. In various embodiments, the architecture of CPU 1010 can be compliant with any of a variety of commercially distributed architecture families including the RS/6000 family, the Motorola 68000 family, or the Intel x86 family.

System bus 1014 also is coupled to memory 1008 that includes both read only memory (ROM) and random access memory (RAM). Non-volatile portions of memory 1008 or the ROM can be encoded with a boot code sequence suitable for restoring computer 900 (FIG. 9) to a functional state after a system reset. In addition, memory 1008 can include microcode such as a Basic Input-Output System (BIOS). In some examples, memory 1008 can include memory 116 (FIG. 1).

In the depicted embodiment of FIG. 10, various I/O devices such as a disk controller 1004, a graphics adapter 1024, a video controller 1002, a keyboard adapter 1026, a mouse adapter 1006, a network adapter 1020, and other I/O devices 1022 can be coupled to system bus 1014. Keyboard adapter 1026 and mouse adapter 1006 are coupled to a keyboard 904 (FIGS. 9 and 10) and a mouse 910 (FIGS. 9 and 10), respectively, of computer 900 (FIG. 9). While graphics adapter 1024 and video controller 1002 are indicated as distinct units in FIG. 10, video controller 1002 can be integrated into graphics adapter 1024, or vice versa in other embodiments. Video controller 1002 is suitable for refreshing a monitor 906 (FIGS. 9 and 10) to display images on a screen 908 (FIG. 9) of computer 900 (FIG. 9). Disk controller 1004 can control hard drive 914 (FIGS. 9 and 10), floppy disc drive 912 (FIGS. 9 and 10), and CD-ROM or DVD drive 916 (FIGS. 9 and 10). In other embodiments, distinct units can be used to control each of these devices separately.

Although many other components of computer 900 (FIG. 9) are not shown, such components and their interconnection are well known to those of ordinary skill in the art. Accordingly, further details concerning the construction and composition of computer 900 and the circuit boards inside chassis 902 (FIG. 9) need not be discussed herein.

When computer 900 in FIG. 9 is running, program instructions stored on a floppy disc in floppy disc drive 912, on a CD-ROM or DVD in CD-ROM and/or DVD drive 916, on hard drive 914, or in memory 1008 (FIG. 10) are executed by CPU 1010 (FIG. 10). A portion of the program instructions, stored on these devices, can be suitable for carrying out method 400 (FIG. 4) as described previously with respect to FIGS. 1-8.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activity 460-474 of FIG. 4 or any element of FIG. 1 may be comprised of many different activities, procedures and be performed by many different modules, in many different orders and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of advertising, the method comprising:
facilitating providing of a first promotional code to a user, the first promotional code provides at least one privilege to the user;
facilitating providing of a first software application to the user;
receiving the first promotional code from the first software application; and
changing one or more first elements of the first software application based on the first promotional code to alter a look and feel of the first software application, wherein changing the one or more first elements comprises:
embedding one or more promotional materials in one or more user screens of the first software application.

2. The method of claim 1, wherein:
embedding the promotional materials comprises:
inserting a logo of a sponsoring entity into the one or more user screens of the first software application.

3. The method of claim 2, wherein:
embedding the promotional materials further comprises:
changing a color of a background of the one or more user screens of the first software application.

4. The method of claim 1, wherein:
facilitating providing of the first promotional code to the user comprises:
providing the first promotional code to a sponsoring entity.

5. The method of claim 4, wherein:
embedding the promotional materials comprises:
branding the one or more user screens of the first software application with the promotional materials of the sponsoring entity.

6. The method of claim 1, wherein:
changing the one or more first elements of the first software application further comprises:
activating one or more features of the first software application based on the at least one privilege of the first promotional code.

7. The method of claim 1, wherein:
changing the one or more first elements of the first software application further comprises at least one of:
providing a discount on a price of the first software application;
providing free use of the first software application for a predetermined period of time; or
use of the first software application for a predetermined number of times.

8. The method of claim 1, wherein:
receiving the first promotional code further comprises receiving the first promotional code from the first software application at a server computer; and
the method further comprises:
determining the one or more first elements of the first software application to change based on the at least one privilege of the first promotional code by accessing information stored in a database, the server computer comprises the database; and
transmitting data to the first software application regarding the one or more first elements of the first software.

9. The method of claim 1, further comprising:
contracting with a sponsoring entity to establish the at least one privilege of the first promotional code.

10. The method of claim 1, further comprising:
contracting with a software provider to establish the at least one privilege of the first promotional code.

11. The method of claim 1, further comprising:
generating the first promotional code for a sponsoring entity with the at least one privilege, wherein:
facilitating providing of the first promotional code to a user comprises:
providing the first promotional code to the sponsoring entity.

12. The method of claim 1, further comprising:
facilitating installing the first software application on a mobile device.

13. The method of claim 1, further comprising:
receiving a second promotional code from the first software application;
determining a precedence between the first promotional code and the second promotional code; and
changing the one or more first elements of the first software application based on the second promotional code if the second promotional code has precedence over the first promotional code.

14. The method of claim 1, wherein:
the first software application is configured to run on a mobile device.

15. The method of claim 1, wherein:
the first software application is configured to run on a personal computer.

16. The method of claim 1, wherein:
the promotional code is an alpha numeric code.

17. The method of claim 1, wherein:
facilitating providing of the first software application to the user comprises:
facilitating the providing of a sports wager tracking application to the user;
embedding the one or more promotional materials comprises:
embedding the one or more promotional materials for a casino in the one or more user screens of the sports wager tracking application; and
the first software application comprises the sports wager tracking application.

18. A system configured to facilitate advertising to one or more users of one or more user computing devices, the system comprising:
a user module configured to run on the one or more user computing devices; and
a server module configured to run on a server computer, the server module comprising:
a download module configured to facilitate the downloading of the user module to the one or more user computing devices; and
a promotional code module configured to determine one or more first elements of the user module to change based on one or more promotional codes,
wherein:
the user module comprises:
a feature module configured to provide one or more features;
a communications module configured to receive the one or more promotional codes from the one or more users and to communicate with the server module; and
an implementation module configured to change the one or more first elements of the user module based on the one or more promotional codes.

19. The system of claim 18, wherein:
the implementation module is configured to change an appearance of one or more user screens of the user module based on the one or more promotional codes;
the implementation module is further configured to provide use of the one or more features for a predetermined time based on one or more privileges of the one or more promotional codes.

20. A method of providing a first software application to one or more users, the method comprising:
entering an agreement with a distributor regarding distribution of the first software application;
creating one or more promotional codes for the distributor based on the agreement;
facilitating providing of the one or more promotional codes to the one or more users;
facilitating downloading of the first software application by the one or more users, wherein facilitating downloading comprises at least one of the following:
providing the distributor the first software application for distribution to the one or more users; or
distributing the first software application to the one or more users;
facilitating installing of the first software application in one or more user computing devices of the one or more users;
receiving at a server computer a first promotional code of the one or more promotional codes from the first software application on a first one of the one or more user computing devices;
determining one or more benefits of the first promotional code of the one or more promotional codes;
transmitting information regarding the one or more benefits to the first software application running on the first one of the one or more user computing devices to implementing the one or more benefits of the first promotional code in the first software application running on the first one of the one or more user computing devices; and
branding one or more user screens of the first software application running on the first one of the one or more user computing devices with advertising materials of the distributor.

21. The method of claim 20, wherein:
Transmitting the information further comprises at least one of the following:
providing a discount on a price of the first software application;
providing free use of the first software application for a predetermined period of time;
enabling one or more features of the first software application; or
allowing free use of the first software application for a predetermined number of times.
